(19) United States
(12) Patent Application Publication
(10) Pub. No.: US 2016/0288302 A1
(43) Pub. Date: Oct. 6, 2016

(54) Ratchet Mechanism

(71) Applicant: Wheelfloat, Inc., Southlake, TX (US)

(72) Inventors: Jonathan D. Snook, Southlake, TX (US); Thomas G. Fulbright, Keller, TX (US)

(73) Assignee: Wheelfloat, Inc., Southlake, TX (US)

(21) Appl. No.: 15/090,491

(22) Filed: Apr. 4, 2016

Related U.S. Application Data
(63) Continuation-in-part of application No. 14/677,698, filed on Apr. 2, 2015.

(51) Int. Cl. B25B 15/04; B25B 13/46

(52) U.S. Cl. CPC B25B 15/04; B25B 13/463

(57) ABSTRACT

A ratchet mechanism includes a base and a shaft having gear teeth rotatably mounted on the base. A bearing is mounted on the base and is rotatable to clockwise and counterclockwise positions, and includes first and second bearing magnets. First and second pawls are slidably positioned on the base, and are slidable between engaged and disengaged positions in which the pawls engage and disengage, respectively, the gear teeth. First and second pawl magnets are embedded in the first and second pawls in magnetic relation to the first and second bearing magnets such that when the bearing is rotated to the clockwise or counterclockwise positions, the first and second bearing magnets bias the first and second pawl magnets to cause the first and second pawls to slide to respective engaged and disengaged positions, or disengaged and engaged positions, thereby enabling the shaft to rotate one of clockwise or counterclockwise directions.

### CROSS-REFERENCE TO RELATED APPLICATIONS

This application claims the benefit of U.S. patent application Ser. No. 14/677,698, filed Apr. 2, 2015, which application is hereby incorporated herein by reference, in its entirety.

### TECHNICAL FIELD

The invention relates generally to ratchets and, more particularly, to ratchets for screwdrivers, socket wrenches, and the like.

### BACKGROUND

Screwdrivers and socket wrenches are well-known for their ability to tighten and loosen fasteners, such as screws, bolts, and the like. A drawback with many screwdrivers and socket wrenches, though, is that, while tightening or loosening a fastener, a user must continually tighten his grip while turning the screwdriver in one direction, and loosen his grip when turning the screwdriver in the other direction. One solution to such a drawback is to integrate a ratchet to the screwdriver or socket wrench, so that the ratchet controls the application of torque to a screwdriver or socket wrench, to tighten or loosen a fastener. A problem with traditional ratchets, though, is that the pawls which engage and disengage the ratchet gear are biased using leaf or coil springs which contact both the pawl and the ratchet housing and therefore transmit vibration and noise from the pawls to the ratchet housing. A further problem with traditional ratchets is that, in order for the springs to push on the pawls, enough space must be available for the pawls to sit between the spring and the gear, making the ratchet mechanism large and cumbersome. Ratchets using one-way bearings rather than pawls and gears have been used to eliminate noise vibration and friction, but such bearings are bulky and only allow clockwise and counter-clockwise operation, and do not allow a third position which is bi-directional, or locked for transferring torque in both directions.

Therefore, what is needed is a ratchet that may be integrated with a screwdriver or socket wrench and that has less noise and vibration than traditional ratchets, and that is also smaller than traditional ratchets, while also allowing clockwise, counter-clockwise, and bi-directional operation of the ratchet.

### SUMMARY

The present invention, accordingly, provides a ratchet mechanism having a base preferably mounted to a handle, wherein the base defines a first pawl cavity, a second pawl cavity, and a shaft bore. A shaft is rotatably positioned in the shaft bore, wherein the shaft includes gear teeth circumscribing at least a portion of the shaft proximate to the pawl cavities. The shaft further includes a driver at an end thereof, the driver being, for example, a socket to which any of a number of bits may be mounted. By way of example, but not limitation, bits may be of any suitable or desirable shape, such as a slotted (flat) head, a Philips head, a square or hex socket, spanner head, spline drive, or the like.

A bearing is mounted on the base, and is selectively rotatable to at least a clockwise position for enabling clockwise rotation of the shaft, and a counterclockwise position for enabling counterclockwise rotation of the shaft. The bearing includes a first bearing magnet and a second bearing magnet mounted in the bearing.

A first pawl is slidably positioned in the first pawl cavity of the base, and is slidable between an engaged position in which the first pawl engages the gear teeth, and a disengaged position in which the first pawl is not engaged with the gear teeth. A first pawl magnet is embedded in the first pawl in magnetic relation to the first bearing magnet such that when the bearing is rotated to the clockwise position, the first bearing magnet biases the first pawl magnet to cause the first pawl to slide to the engaged position, and when the bearing is rotated to the counterclockwise position, the first bearing magnet biases the first pawl magnet to cause the first pawl to slide to the disengaged position.

A second pawl is slidably positioned in the second pawl cavity of the base, and is slidable between an engaged position in which the second pawl engages the gear teeth, and a disengaged position in which the second pawl does not engage the gear teeth. A second pawl magnet is embedded in the second pawl in magnetic relation to the second bearing magnet such that when the bearing is rotated to the clockwise position, the second bearing magnet biases the second pawl magnet to cause the second pawl to slide to the disengaged position, and when the bearing is rotated to the counterclockwise position, the second bearing magnet biases the second pawl magnet to cause the second pawl to slide to the engaged position.

In a further embodiment, the bearing may be rotated to a bi-directional position between clockwise and counterclockwise positions to allow torque to be transmitted in both clockwise and counterclockwise directions.

In a still further embodiment, the pawls are fabricated from a ferromagnetic material, and a magnet is positioned in the base for biasing each respective pawls to engage the gear teeth. A pin extends upwardly from each pawl into a respective hole of a bearing for restraining a first pawl from engaging the gear teeth in a first direction, and for restraining a second pawl from engaging the gear teeth in a second direction.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a screwdriver embodying features of the present invention;

FIG. 2 is a cross-section of the screwdriver of FIG. 1 taken along line 2-2 of FIG. 1;

FIG. 3 is a perspective view of a ratchet mechanism embodying features of the present invention;

FIG. 4 is a cross-section of the ratchet mechanism taken along line 4-4 of FIG. 3;

FIG. 5A is a cross-section of the ratchet mechanism taken along line 5-5 of FIG. 4, and magnetically biased to transfer torque in two directions;

FIG. 5B is a cross-section of the ratchet mechanism taken along line 5-5 of FIG. 4, and magnetically biased to transfer torque in a first direction;

FIG. 5C is a cross-section of the ratchet mechanism taken along line 5-5 of FIG. 4, and magnetically biased to transfer torque in a second direction;

FIG. 6 is a perspective view of an alternative embodiment of the ratchet mechanism embodying features of the present invention;

FIG. 7 is a cross-section of the ratchet mechanism taken along line 7-7 of FIG. 8A;

FIG. 8A is a cross-section of the ratchet mechanism taken along line 8-8 of FIG. 7, and magnetically biased to transfer torque in two directions;

FIG. 8B is a cross-section of the ratchet mechanism taken along line 8-8 of FIG. 7, and magnetically biased to transfer torque in a first direction;

FIG. 8C is a cross-section of the ratchet mechanism taken along line 8-8 of FIG. 7, and magnetically biased to transfer torque in a second direction;

FIG. 9 is a perspective view of a further alternative embodiment of the ratchet mechanism embodying features of the present invention;

FIG. 10 depicts a bearing utilized in the alternative embodiment of FIG. 9;

FIG. 11 depicts the bearing of FIG. 10 assembled to the embodiment of FIG. 9;

FIG. 12 is cross-section of the embodiment of FIG. 11 taken along the line 12-12 of FIG. 11;

FIG. 13A is a cross-section of the ratchet mechanism of FIG. 12 taken along line 13-13 of FIG. 12, and magnetically biased to transfer torque in two directions;

FIG. 13B is a cross-section of the ratchet mechanism of FIG. 12 taken along line 13-13 of FIG. 12, and magnetically biased to transfer torque in a first direction; and

FIG. 13C is a cross-section of the ratchet mechanism of FIG. 12 taken along line 13-13 of FIG. 12, and magnetically biased to transfer torque in a second direction.

### DETAILED DESCRIPTION

Refer now to the drawings wherein depicted elements are, for the sake of clarity, not necessarily shown to scale and wherein like or similar elements are designated by the same reference numeral through the several views. The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation. Refer now to the drawings wherein like or similar elements are designated by the same reference numeral through the several views.

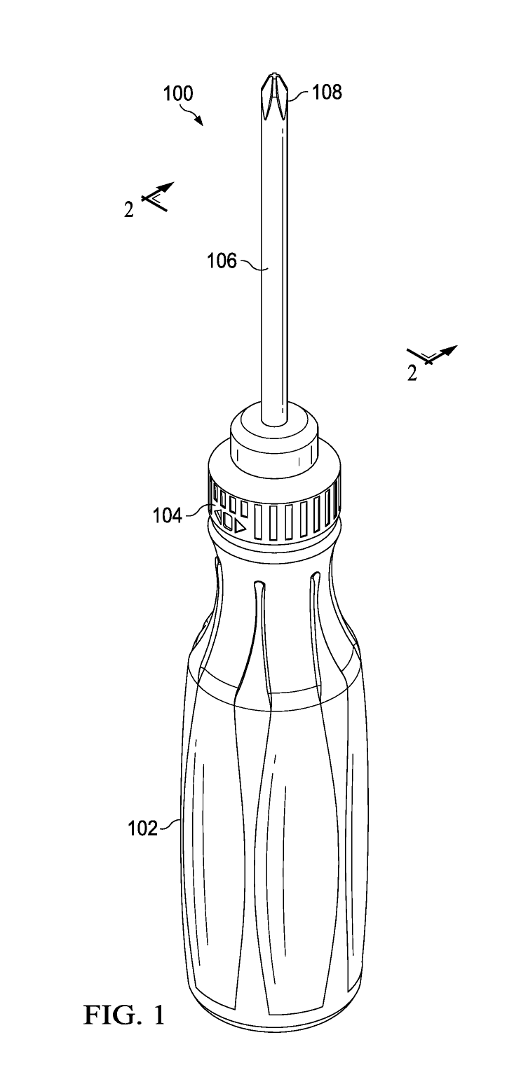

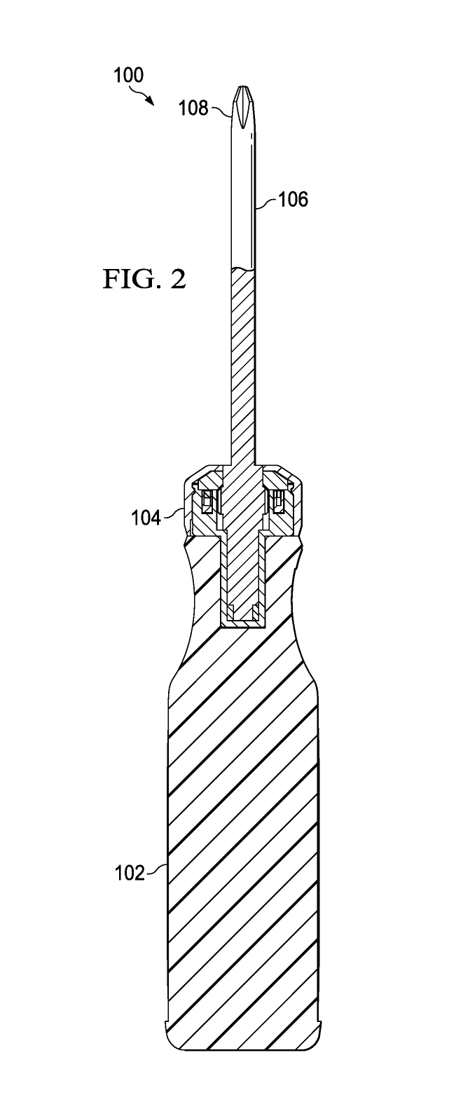

Referring to FIG. 1 of the drawings, the reference numeral 100 generally designates a screwdriver having a ratchet embodying features of the present invention. The screwdriver 100 includes a handle portion 102, a shaft 106 extending from the handle portion 102 to a driver 108, and a ratchet 104 interposed between the handle portion 102 and driver 108, all of which portions will be described in further detail below. FIG. 2 is a cross-sectional view of the screwdriver 100 of FIG. 1

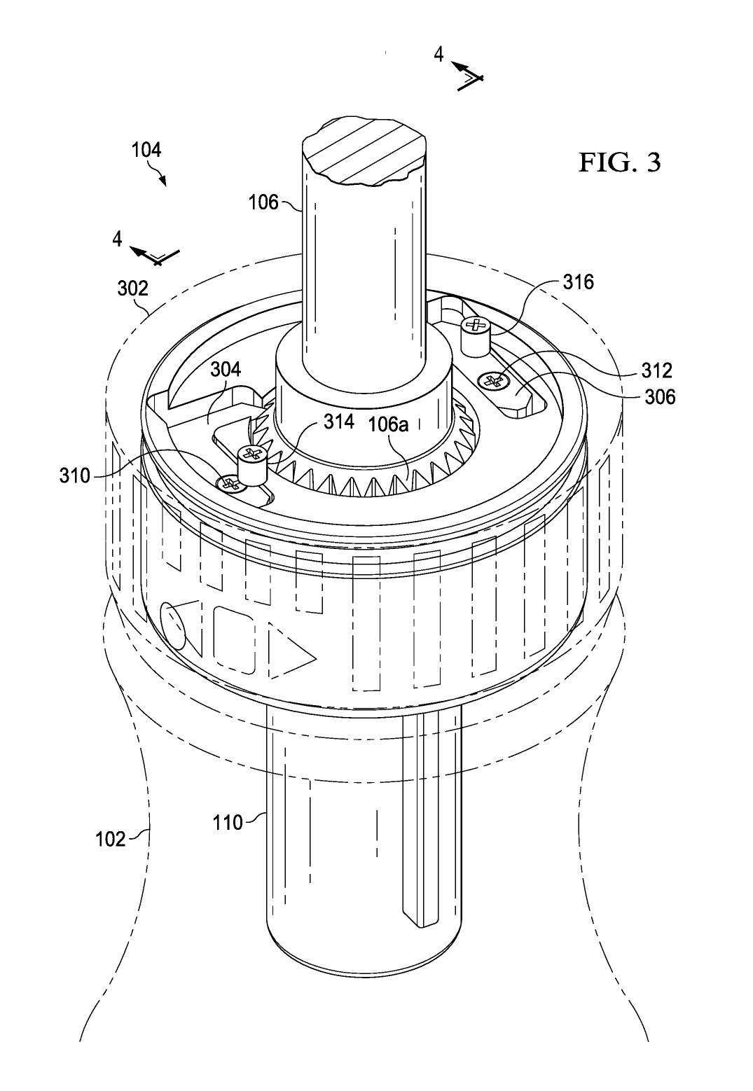

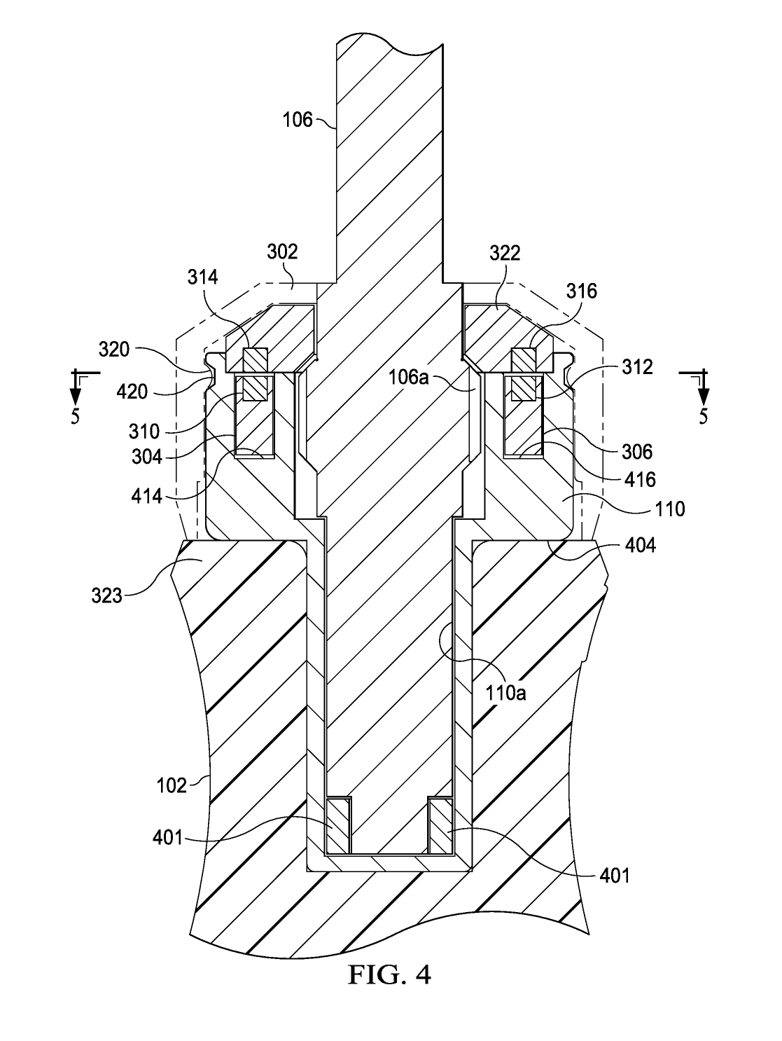

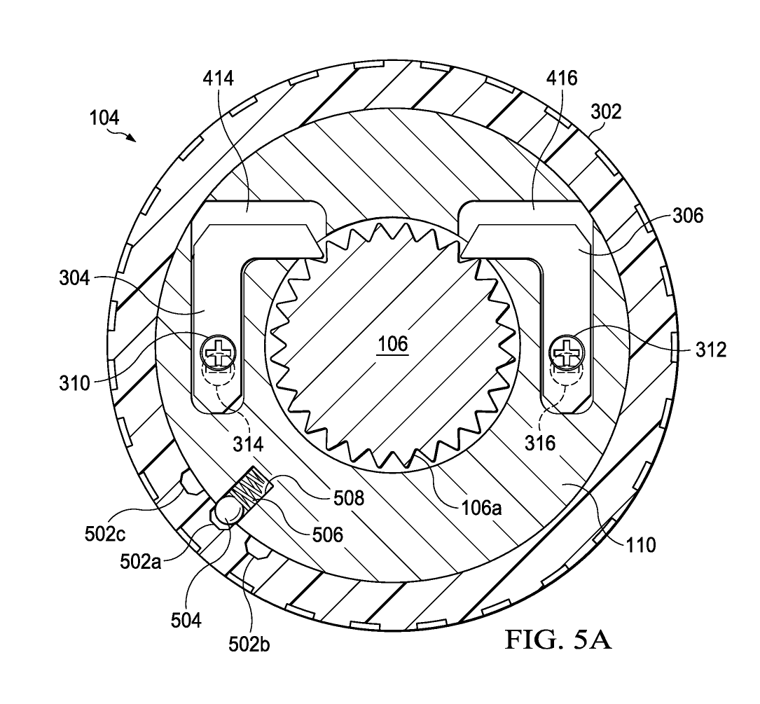

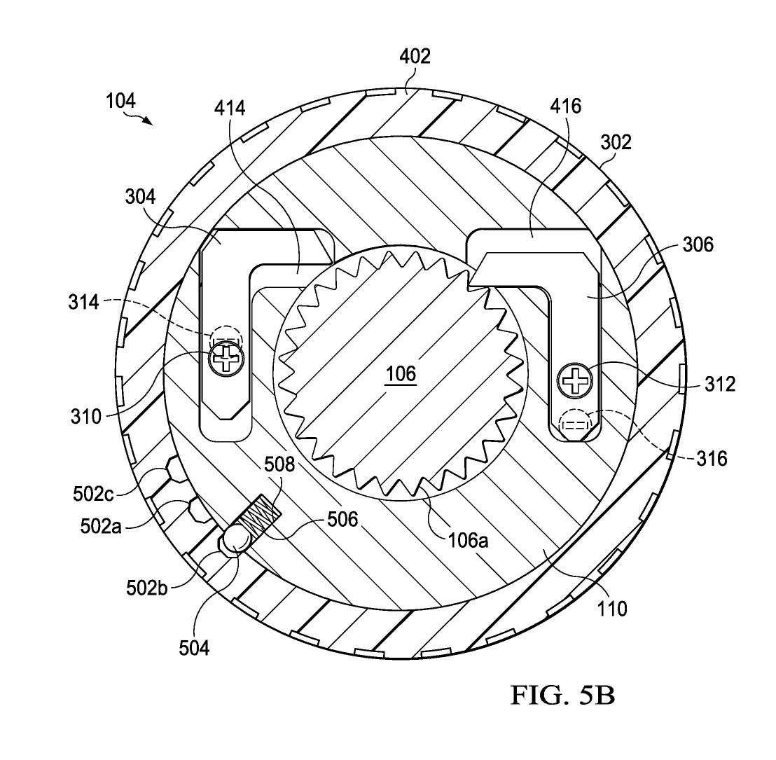

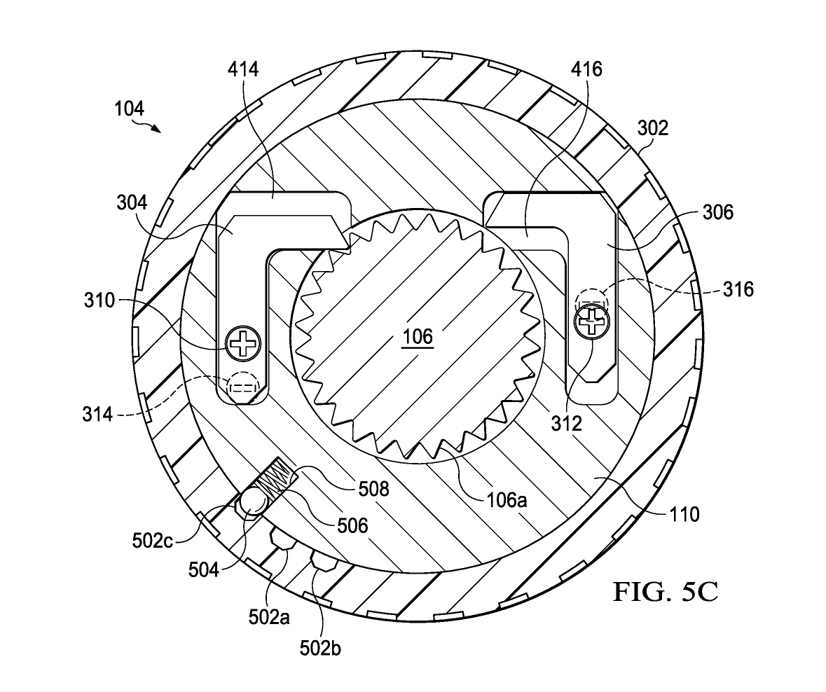

FIG. 3 is a perspective view of the ratchet 104, and FIG. 4 is a cross-sectional view of the ratchet 104 taken along the line 4-4 of FIG. 3. The ratchet 104 includes a base 110 which defines a well 110a and two pawl cavities 416 and 414. The well 110a extends into and is secured in the handle 102. A shaft 106, including gear teeth 106a, is rotatably mounted in the well 110a, and preferably includes roller and thrust bearing 401 positioned in the bottom of the well between the shaft 106 and the well 110a. Pawls 304 and 306 are slidably positioned in pawl cavities 414 and 416, respectively, for engaging gear teeth 106a. Magnets 310 and 312 are embedded in pawls 304 and 306, respectively, and are flush with the upper surface of respective pawls. An upper bearing 322 is rotatably secured atop ratchet base 110 for imparting upper rotational stability to shaft 106, and is secured in any convention manner (e.g., mating tab and cutout) for synchronous rotation with the ratchet cover 302. Magnets 314 and 316 are embedded in upper bearing 322 for magnetically biasing magnets 310 and 312, respectively, as discussed further below with respect to FIGS. 5A-5C. A ratchet cover 302 is preferably positioned over the bearing 322 and ratchet base 110 and is seated on the screwdriver handle 102. It may thus be appreciated that upper bearing 322 and magnets 314 and 316 move synchronously with ratchet cover 302. In an alternative embodiment, upper bearing 322 and magnets 314 and 316 may be integrated into ratchet cover 302.

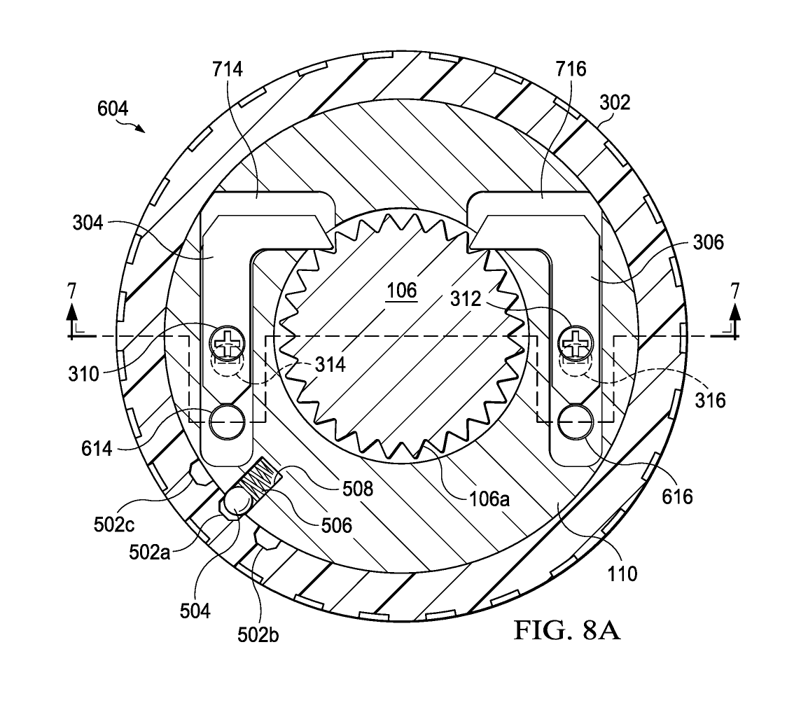

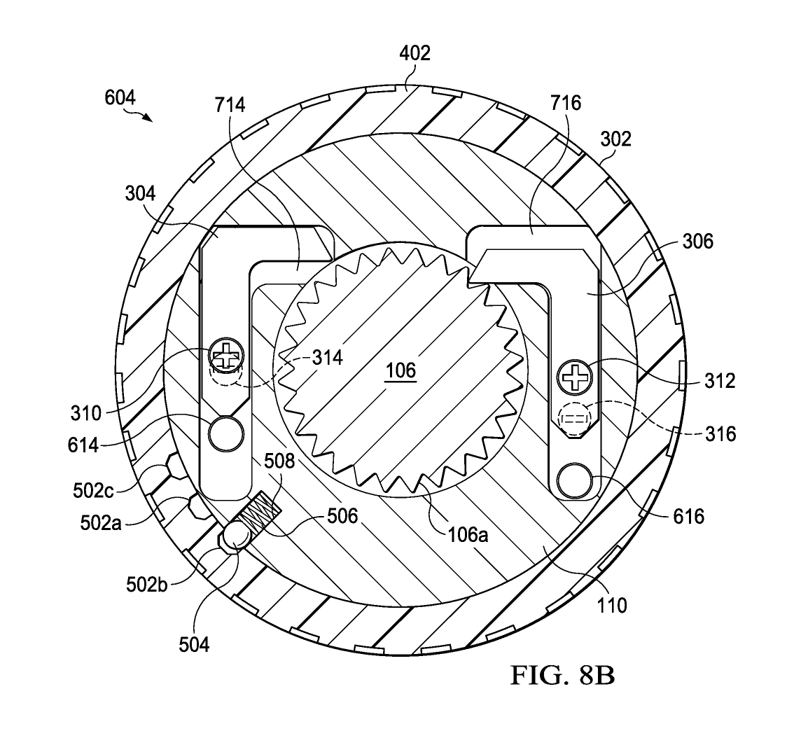

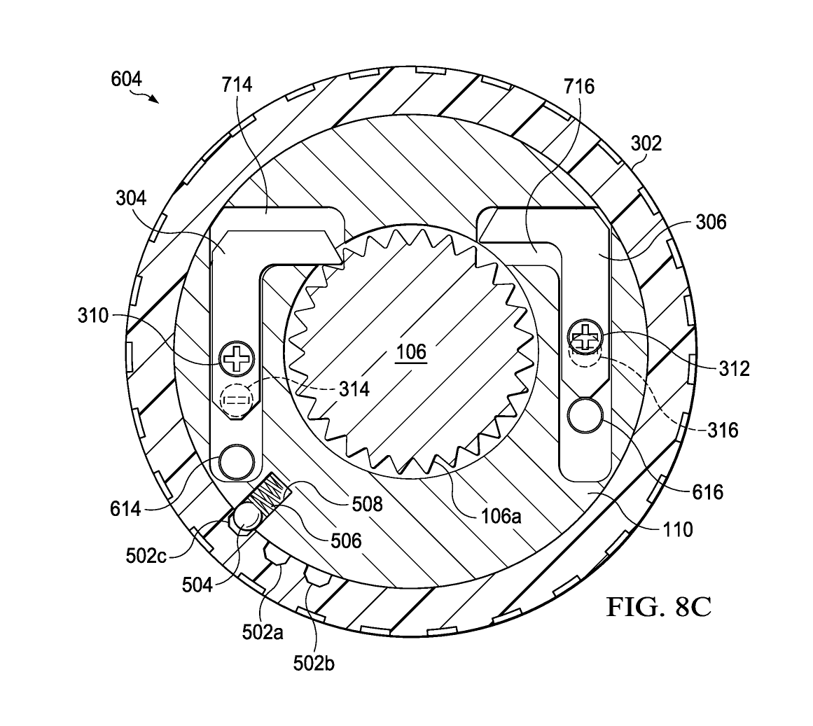

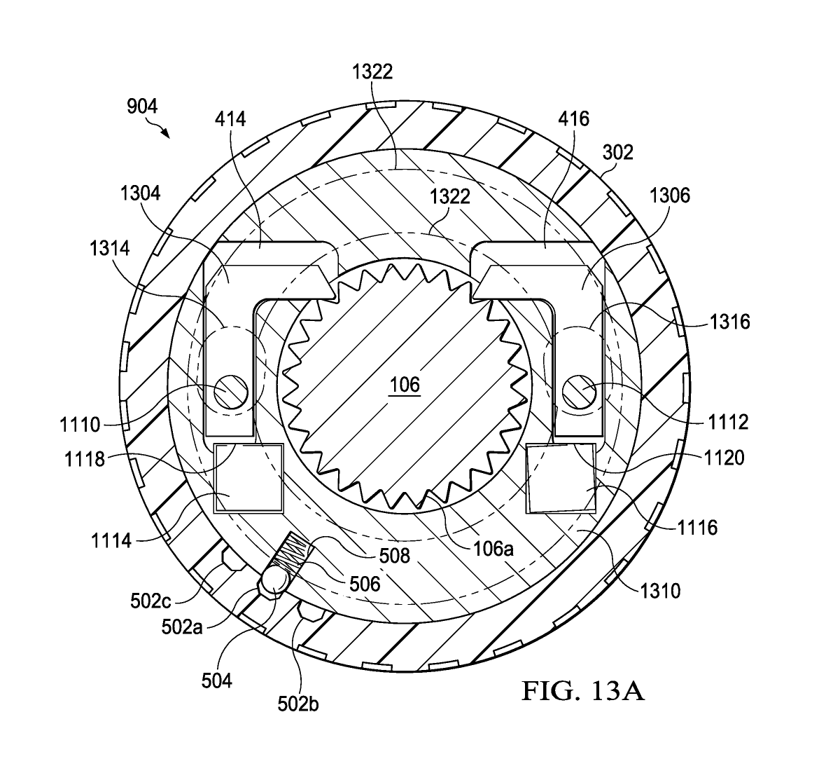

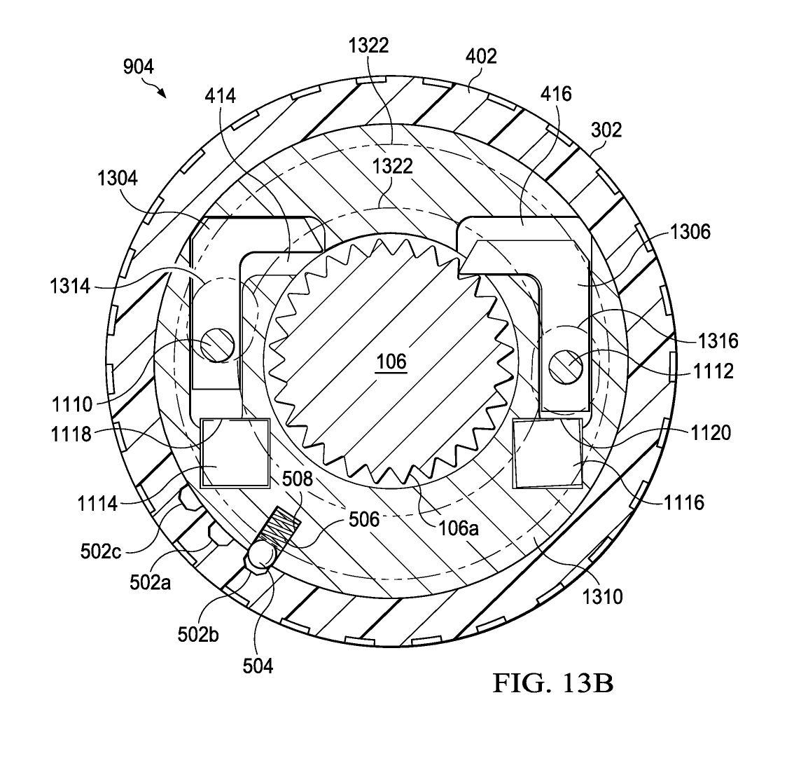

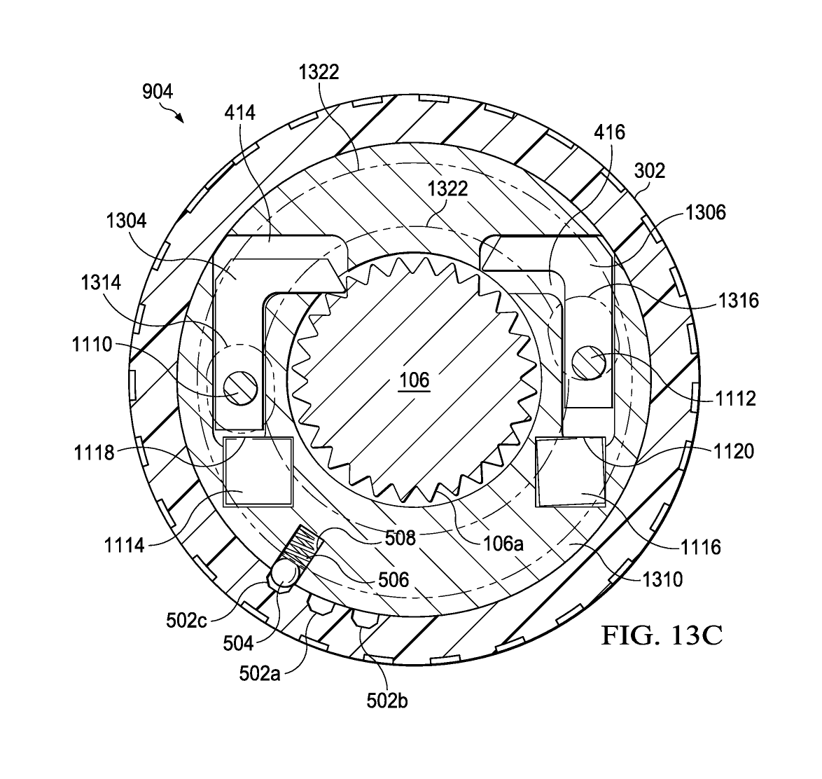

FIGS. 5A-5C are cross-sectional views of the ratchet 104 taken along the line 5-5 of FIG. 4, showing three different modes of operation of the ratchet. To establish a mode, ratchet base 110 and ratchet cover 302 are preferably provided with conventional complementary ball and detents operable to secure the ratchet cover relative to the ratchet base in three user-selectable positions corresponding to the three modes of operation. Specifically, in a preferred embodiment, the ratchet base 110 defines a bore 508 sized for receiving a spring 506 compressed for urging a ball 504 outwardly from the ratchet base 110. Ratchet cover 302 preferably defines three complementary detents 502a, 502b, and 502c positioned so that one of the three detents receives ball 504 for each mode the ratchet is selectively set to, and secures the ratchet in such selected position for operation, discussed below. It is understood that the complementary ball and detents may be configured at locations between the ratchet base 110 and ratchet cover 302 that differ from that shown in FIGS. 5A, 5B, and 5C, as well as FIGS. 8A, 8B, 8C, 13A, 13B, and 13C discussed below. Furthermore, it is considered that complementary ball and detents are well-known in the art for securing complementary parts in selected positions and, therefore, will not be discussed in further detail herein, except to the extent necessary to explain operation of the invention.

FIG. 5A exemplifies a first, or bi-directional, mode or operation of the ratchet 104 in which the shaft 106 rotates synchronously with the handle 102 to transfer torque in both clockwise and counterclockwise directions. Accordingly, the ratchet cover 302, and hence upper bearing 322 and magnets 314 and 316 which move synchronously with the ratchet cover, as discussed above, is rotated relative to the ratchet base 110 so that ball 504 is seated in a middle, or bi-directional, detent 502a. The magnets 314 and 316 are then positioned to bias magnets 310 and 312, as well as pawls 304 and 306, downwardly, as viewed in FIG. 5A, thereby causing each pawl to engage gear teeth 106a of shaft 106. Pawl 304 imparts clockwise rotation of shaft 106, and pawl 306 imparts counterclockwise rotation of shaft 106. It may be appreciated then that, in the first mode, shaft 106 rotates synchronously with the handle 102 to transfer torque in both clockwise and counterclockwise directions.

FIG. 5B exemplifies a second mode of operation of ratchet 104 in which shaft 106 rotates synchronously with the handle 102 to transfer torque in a counterclockwise direction, but not in a clockwise direction, a mode commonly used to loosen fasteners, such as screws. Accordingly, the ratchet cover 302, and hence upper bearing 322 and magnets 314 and 316 as discussed above, is rotated clockwise relative to the ratchet base 110 and handle 102 so that ball 504 is seated in a corresponding detent 502b. The magnets 314 and 316 are then positioned to bias magnet 310 and pawl 304 upwardly, and to bias magnet 312 and pawl 306 downwardly, as viewed in FIG. 5B, causing pawl 306 to engage gear teeth 106a of shaft 106, and causing pawl 304 to disengage from gear teeth 106a of shaft 106. It may be appreciated then that, in the second mode, when a user turns handle 102 in a tightening (i.e., clockwise) direction, pawl 306 skips over one or more gear teeth 106a while maintaining contact with gear teeth 106a under bias from magnet 316, and shaft 106 does not turn with handle 102, and torque is not transferred from handle 102 to shaft 106. However, as soon as a user turns handle 102 in a loosening (i.e., counterclockwise) direction, pawl 306 engages a gear tooth 106a, and shaft 106 turns with handle 102, and torque is transferred from handle 102 to shaft 106.

FIG. 5C exemplifies a third mode of operation of ratchet 104 in which shaft 106 rotates synchronously with handle 102 to transfer torque in a clockwise direction, but not in a counterclockwise direction, a mode commonly used to tighten fasteners, such as screws. Accordingly, ratchet cover 302, and hence upper bearing 322 and magnets 314 and 316 as discussed above, are rotated counterclockwise relative to ratchet base 110 and handle 102 so ball 504 is seated in corresponding detent 502c. The magnets 314 and 316 are then positioned to bias magnet 310 and pawl 304 downwardly, and to bias magnet 312 and pawl 306 upwardly, as viewed in FIG. 5C, causing pawl 306 to disengage from gear teeth 106a of shaft 106, and causing pawl 304 to engage gear teeth 106a of shaft 106. It may be appreciated then that, in the third mode, when a user turns handle 102 in a loosening (i.e., counterclockwise) direction, pawl 304 skips over one or more gear teeth 106a while maintaining contact with gear teeth 106a under bias from magnet 312, and shaft 106 does not turn with handle 102, and torque is not transferred from handle 102 to shaft 106. However, as soon as a user turns handle 102 in a tightening (i.e., clockwise) direction, pawl 304 engages a gear tooth 106a, and shaft 106 turns with handle 102, and torque is transferred from handle 102 to shaft 106.

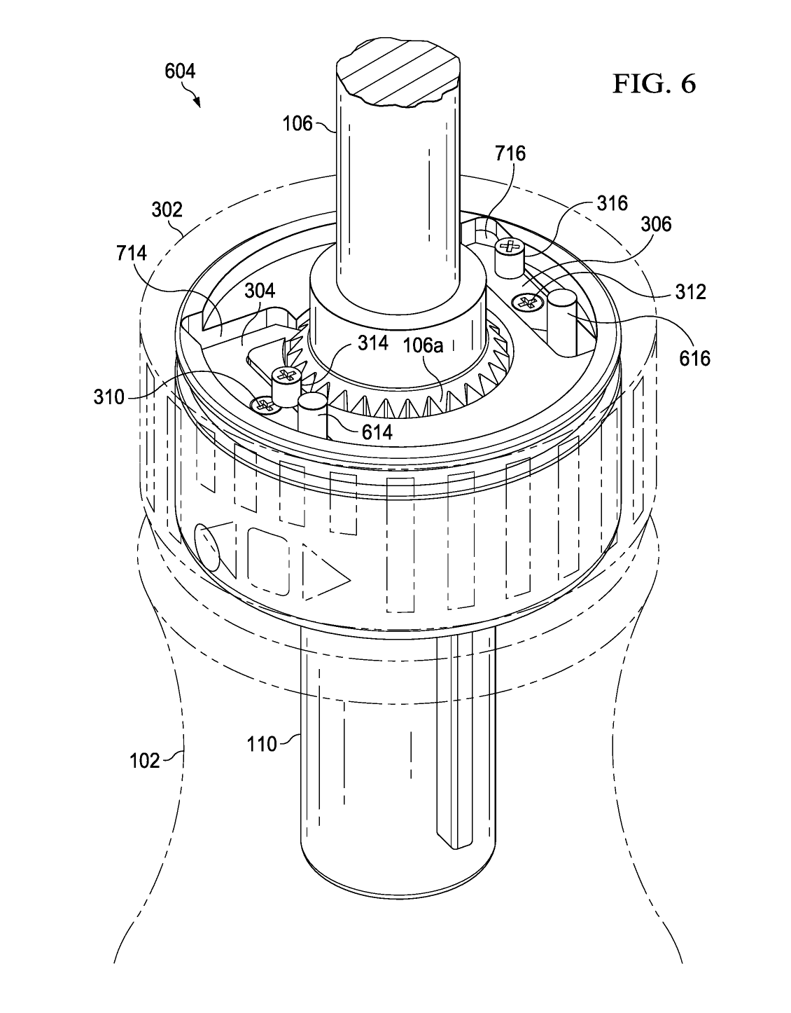

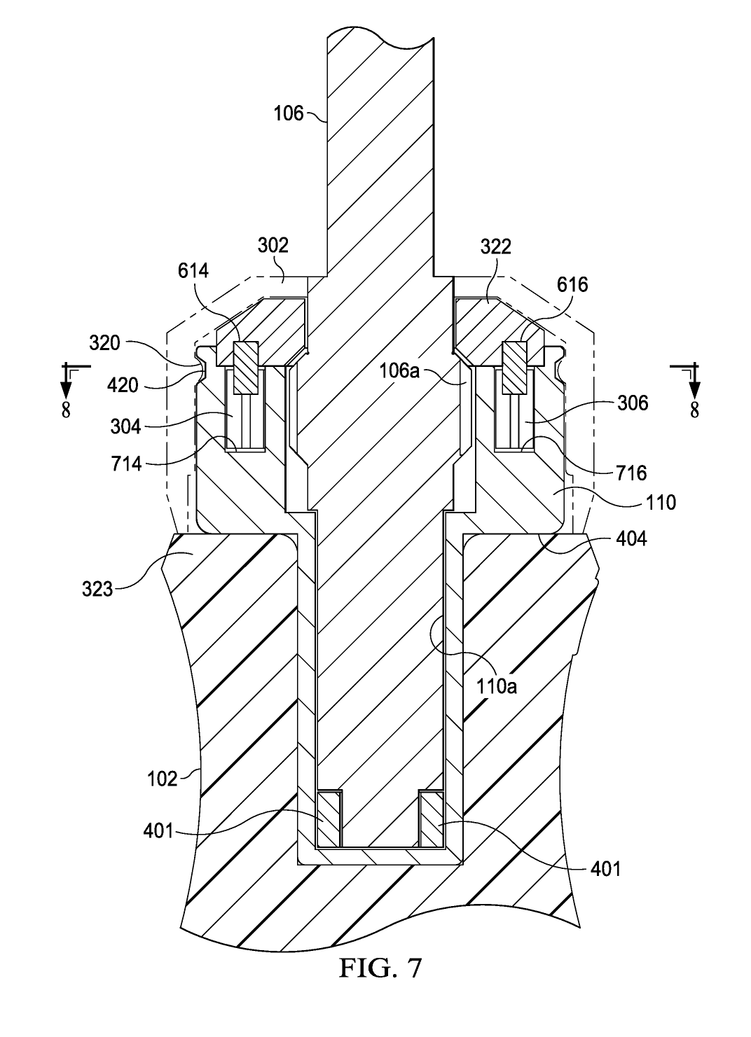

FIGS. 6-8C exemplify an alternative embodiment 604 of the ratchet, similar to embodiment 104 of FIGS. 3-5C, but wherein pegs are used to mechanically disengage one of pawls 304 and 306 from gear teeth 106a. Accordingly, as most clearly shown in FIG. 7, pegs 614 and 616 are embedded in bearing 322 (or, alternatively, in the ratchet cover 302 if the bearing is integrated into the ratchet cover) and extend downwardly. It may thus be appreciated that, along with upper bearing 322 and magnets 314 and 316, pegs 614 and 616 also move synchronously with ratchet cover 302. As shown most clearly in FIGS. 8A-8C, pawl cavities 714 and 716 are defined in ratchet base 110 similarly to pawl cavities 414 and 416, but extended downwardly for receiving pegs 614 and 616. Ratchet 604 is otherwise similar to ratchet 104.

As discussed above with respect to ratchet 104, ratchet 604 is operable in three modes. In the first mode, depicted in FIG. 8A, both pawls 304 and 306 engage a gear tooth 106a, thereby transmitting torque from handle 102 to shaft 106 in both clockwise and counterclockwise directions. Hence, in the first mode of operation, when a user turns handle 102 in either direction, torque is transferred to turn shaft 106 in the same direction. Operation in the first mode is otherwise similar to that described above with respect to FIG. 5A.

In the second mode, depicted by FIG. 8B for transmitting torque from handle 102 to shaft 106 in a counterclockwise (i.e., loosening) direction, pawl 304 is urged upwardly (as viewed in FIG. 8B) by peg 614 to thereby prevent pawl 304 from engaging gear teeth 106 and transmitting torque in a clockwise (i.e., tightening) direction. Operation in the second mode is otherwise similar to that described above with respect to FIG. 5B.

In the third mode, depicted by FIG. 8C for transmitting torque from handle 102 to shaft 106 in a clockwise (i.e., tightening) direction, pawl 306 is urged upwardly (as viewed in FIG. 8C) by peg 616 to thereby prevent pawl 306 from engaging gear teeth 106 and transmitting torque in a counterclockwise (i.e., loosening) direction. Operation in the third mode is otherwise similar to that described above with respect to FIG. 5C.

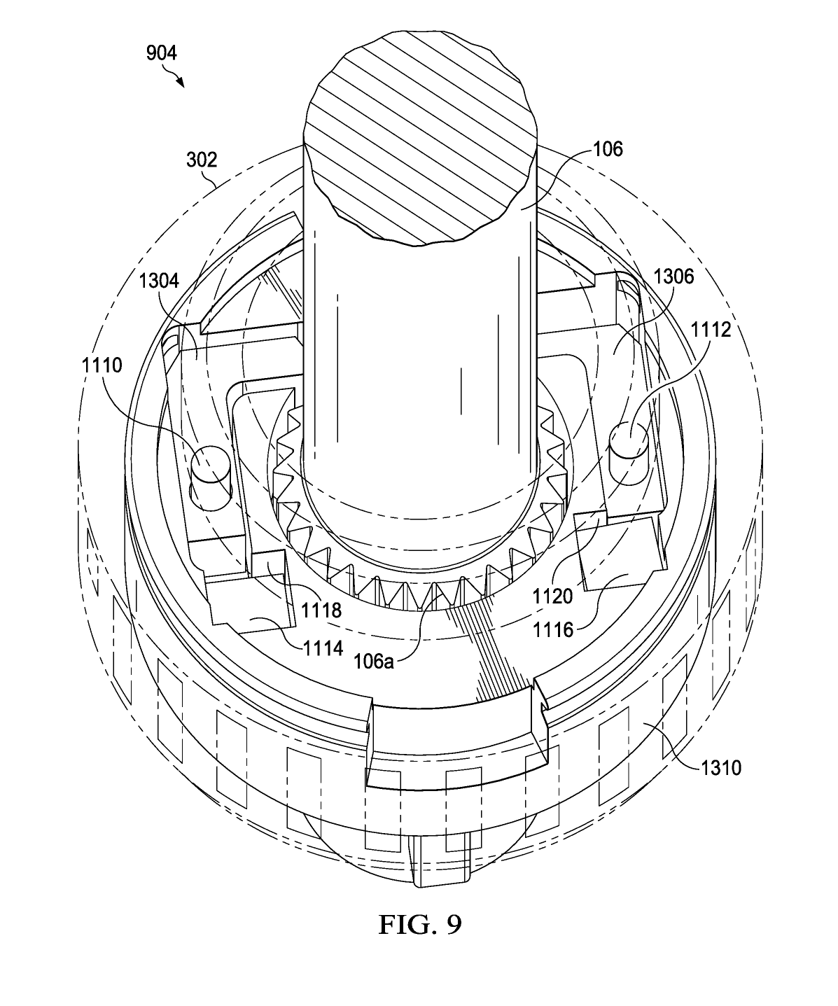

FIGS. 9-13 exemplify an alternative embodiment 904 of the ratchet, similar to embodiments 104 and 604 of FIGS. 3-8C. Unlike ratchets 104 and 604, ratchet 904 utilizes pawls 1304 and 1306 which are fabricated from a magnetic material, preferably a ferromagnetic material such as iron, nickel, cobalt, or the like, that are attracted to magnetic fields. Magnets 1114 and 1116 are positioned adjacent respective pawls 1304 and 1306 in magnet cavities 1118 and 1120 defined in base 1310, corresponding to base 110 in ratchets 104 and 604. As so positioned, magnets 1114 and 1116 bias respective pawls 1304 and 1306 toward the magnets. Pawls 1304 and 1306 further preferably include pins 1110 and 1112 press-fitted in them and extending upwardly. Alternatively, the pawls and respective pins may be fabricated as a single integral part.

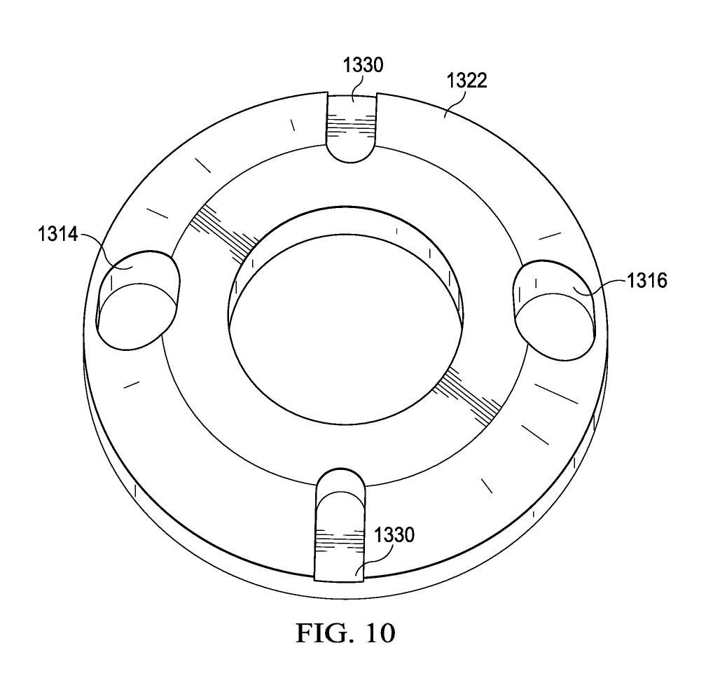

Ratchet 904 further includes a bearing 1322, shown most clearly in FIG. 10, and corresponding to bearing 322 of ratchets 104 and 604. Bearing 1322 is preferably fabricated from plastic, nylon, or other suitable material. Further, bearing 1322 defines two holes (or, alternatively, cavities) 1314 and 1316, for receiving and engaging pins 1110 and 1112, as discussed in further detail below. Two notches 1330 are defined in bearing 1322 for engaging ratchet cover 302 to facilitate synchronous movement of bearing 1322 and holes 1314 and 1316 with ratchet cover 302.

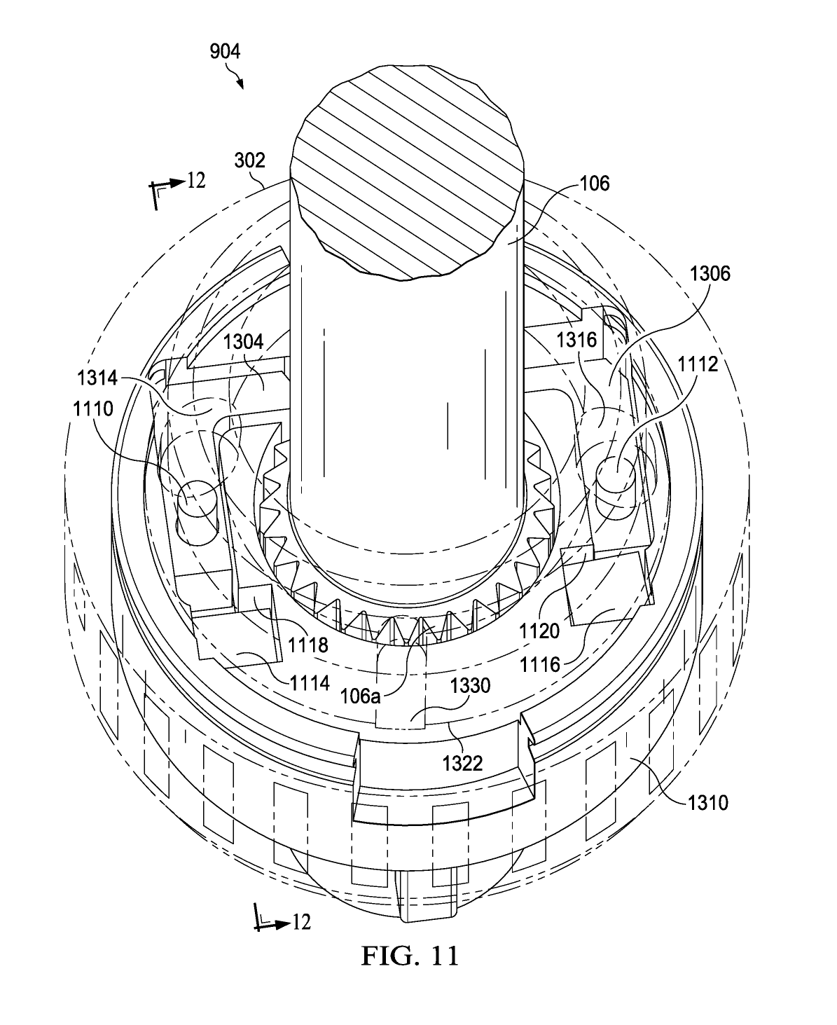

FIG. 11 depicts the assembly of ratchet 904 wherein bearing 1322, shown in dashed outline, is positioned over pawls 1304 and 1306 and magnets 1114 and 1116 so that pins 1110 and 1112 extend through holes 1314 and 1316 of bearing 1322. While not shown in FIG. 11, ratchet cover 302 fits over bearing 1322 so that notches 1330 engage teeth on the interior of the ratchet cover to facilitate synchronous rotation movement between bearing 1322 and ratchet cover 302. Alternatively, bearing 1322 may be integrated into the ratchet cover as a single unit, with a similar function as described herein.

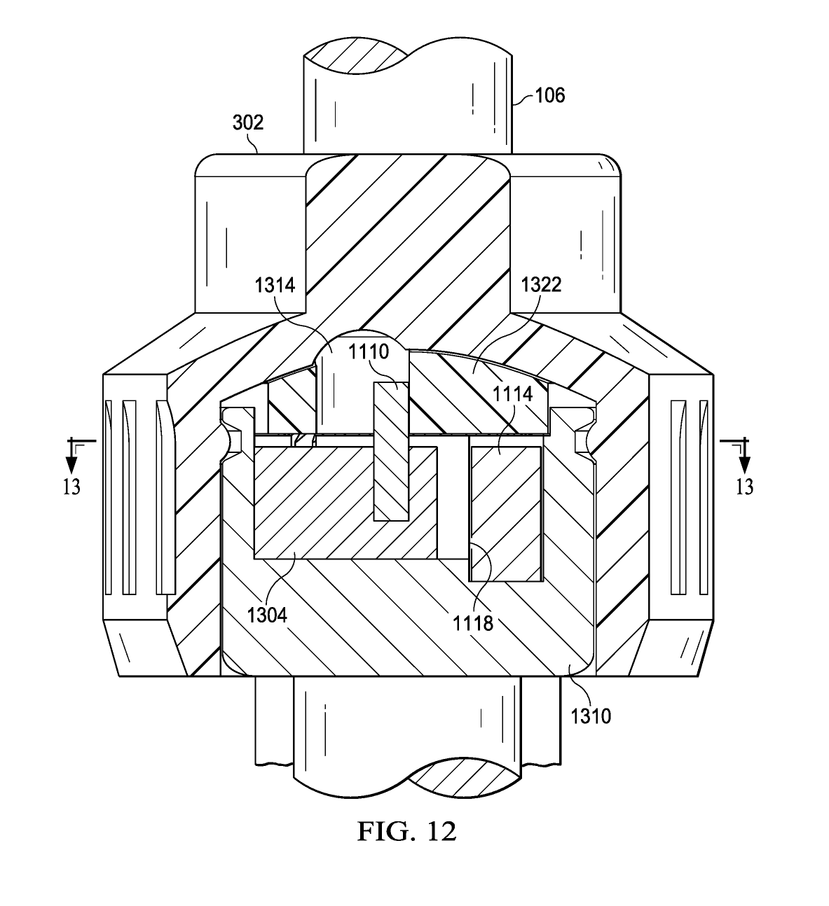

FIG. 12 depicts a cross-section of FIG. 11 taken along the line 12-12 of FIG. 11. As shown therein, magnet 1114 attracts the magnetic material of pawl 1304 toward the magnet, but the pawl is restrained in its movement by pin 1110 extending upwardly from the pawl engaging hole 1314 of bearing 1322 (similar to the position depicted by FIG. 13B, discussed below). It can be appreciated that the position of pawl 1304 may thereby be controlled by bearing 1322, which a user can control by turning ratchet cover 302 in one of three modes, discussed below.

As discussed above with respect to ratchets 104 and 604, ratchet 904 is operable in three modes. In the first mode, depicted by FIG. 13A, holes 1314 and 1316 of bearing 1322 allow both pawls 1304 and 1306 to engage a gear tooth 106a, thereby transmitting torque from handle 102 to shaft 106 in both clockwise and counterclockwise directions. Hence, in the first mode of operation, when a user turns handle 102 in either direction, torque is transferred to turn shaft 106 in the same direction. Operation in the first mode is otherwise similar to that described above with respect to FIG. 5A.

In the second mode, depicted by FIG. 13B for transmitting torque from handle 102 to shaft 106 in a counterclockwise (i.e., loosening) direction, hole 1316 of bearing 1322 allows pawl 1306 to be drawn closer to magnet 1116 and engage a gear tooth 106a. At the same time, pawl 1304 is urged away from magnet 1114 by pin 1110 to thereby prevent pawl 1304 from engaging gear teeth 106a and cause torque to be transmitted in a clockwise (i.e., tightening) direction. Operation in the second mode is otherwise similar to that described above with respect to FIG. 5B.

In the third mode, depicted by FIG. 13C for transmitting torque from handle 102 to shaft 106 in a clockwise (i.e., tightening) direction, hole 1314 of bearing 1322 allows pawl 1304 to be drawn closer to magnet 1114 and engage a gear tooth 106a. At the same time, pawl 1306 is urged away from magnet 1116 by pin 1112 to thereby prevent pawl 1306 from engaging gear teeth 106a and cause torque to be transmitted in a counterclockwise (i.e., loosening) direction. Operation in the third mode is otherwise similar to that described above with respect to FIG. 5C.

It is understood that the present invention may take many forms and embodiments. Accordingly, several variations may be made in the foregoing without departing from the spirit or the scope of the invention. For example, magnets 310, 312, 314, and 316 could be repositioned to enable a mode wherein torque is not transferred in either clockwise or counterclockwise directions. In ratchet 904, pawls 1304 and 1306, or a portion thereof, may also be magnetized and oriented to increase the effective magnetic attraction between pawls 1304 and 1306 and magnets 1114 and 1116. Magnets 1114 and 1116 may also be configured as a Halbach array of permanent magnets to further increase their effective magnetic force.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A ratchet mechanism comprising:
a base mountable to a handle, the base defining a first pawl cavity, a second pawl cavity, and a shaft bore;
a shaft rotatably positioned in the shaft bore, the shaft including gear teeth circumscribing at least a portion of the shaft proximate to the first and second pawl cavities;
an upper bearing mounted on the base, the upper bearing being selectively rotatable to at least a clockwise position for imparting torque in a clockwise direction from a handle to the shaft, the upper bearing being further selectively rotatable to at least a counterclockwise position for imparting torque in a counterclockwise direction from a handle to the shaft, and the upper bearing including a first bearing magnet and a second bearing magnet;
a first pawl slidably positioned in the first pawl cavity, the first pawl being slidable between an engaged position in which the first pawl engages the gear teeth, and a disengaged position in which the first pawl is not engaged with the gear teeth;
a second pawl slidably positioned in the second pawl cavity, the second pawl being slidable between an engaged position in which the second pawl engages the gear teeth, and a disengaged position in which the second pawl is not engaged with the gear teeth;
a first pawl magnet embedded in the first pawl in magnetic relation to the first bearing magnet such that when the upper bearing is rotated to the clockwise position, the first bearing magnet biases the first pawl magnet to slide the first pawl to the engaged position, and when the bearing is rotated to the counterclockwise position, the first bearing magnet biases the first pawl magnet to slide the first pawl to the disengaged position; and
a second pawl magnet embedded in the second pawl in magnetic relation to the second bearing magnet such that when the bearing is rotated to the clockwise position, the second bearing magnet biases the second pawl magnet to slide the second pawl to the disengaged position, and when the bearing is rotated to the counterclockwise position, the second bearing magnet biases the second pawl magnet to slide the second pawl to the engaged position.

2. The ratchet of claim 1, wherein the shaft further includes a driver at an end thereof, for tightening and loosening fasteners.

3. The ratchet of claim 1, wherein the upper bearing is further selectively rotatable to a bidirectional position for imparting torque in both a clockwise direction and a counterclockwise direction from a handle to the shaft.

4. The ratchet of claim 1, further comprising a ratchet cover substantially enveloping the ratchet.

5. The ratchet of claim 1, wherein the upper bearing includes a cover portion configured for substantially enveloping the ratchet.

6. The ratchet of claim 1, further comprising a ratchet cover substantially enveloping the ratchet, wherein the base defines a bore and the ratchet cover defines at least two detents, and wherein the ratchet further comprises a spring and ball positioned in the bore for engaging a selected one of the at least two detents for securing the ratchet in the clockwise position or the counterclockwise position.

7. The ratchet of claim 1, wherein the upper bearing includes a cover portion configured for substantially enveloping the ratchet, wherein the base defines a bore and the cover portion defines at least two detents, and wherein the ratchet further comprises a spring and ball positioned in the bore for engaging a selected one of the at least two detents for securing the ratchet in the clockwise position or the counterclockwise position.

8. The ratchet of claim 1, further comprising a lower bearing interposed in the shaft bore between the shaft and the shaft bore.

9. A ratchet mechanism comprising:
a base mountable to a handle, the base defining a first pawl cavity, a second pawl cavity, and a shaft bore;
a shaft rotatably positioned in the shaft bore, the shaft including gear teeth circumscribing at least a portion of the shaft proximate to the first and second pawl cavities;
an upper bearing mounted on the base, the upper bearing being selectively rotatable to at least a clockwise position for imparting torque in a clockwise direction from a handle to the shaft, the upper bearing being further selectively rotatable to at least a counterclockwise position for imparting torque in a counterclockwise direction from a handle to the shaft, and the upper bearing including a first bearing magnet and a second bearing magnet;
a first pawl slidably positioned in the first pawl cavity, the first pawl being slidable between an engaged position in which the first pawl engages the gear teeth, and a disengaged position in which the first pawl is not engaged with the gear teeth;
a second pawl slidably positioned in the second pawl cavity, the second pawl being slidable between an engaged position in which the second pawl engages the gear teeth, and a disengaged position in which the second pawl is not engaged with the gear teeth;
a first pawl magnet embedded in the first pawl in magnetic relation to the first bearing magnet such that when the upper bearing is rotated to the clockwise position, the first bearing magnet biases the first pawl magnet to slide the first pawl to the engaged position;
a second pawl magnet embedded in the second pawl in magnetic relation to the second bearing magnet such that when the bearing is rotated to the counterclockwise position, the second bearing magnet biases the second pawl magnet to slide the second pawl to the engaged position;
a first peg embedded in the upper bearing and extending into the first pawl cavity, wherein when the upper bearing is rotated to the counterclockwise position, the first peg causes the first pawl to slide to the disengaged position; and
a second peg embedded in the upper bearing and extending into the second pawl cavity, wherein when the upper bearing is rotated to the clockwise position, the second peg causes the second pawl to slide to the disengaged position.

10. The ratchet of claim 9, wherein the shaft further includes a driver at an end thereof, for tightening and loosening fasteners.

11. The ratchet of claim 9, wherein the upper bearing is further selectively rotatable to a bidirectional position for imparting torque in both a clockwise direction and a counterclockwise direction from a handle to the shaft.

12. The ratchet of claim 9, further comprising a ratchet cover substantially enveloping the ratchet.

13. The ratchet of claim 9, wherein the upper bearing includes a cover portion configured for substantially envelopes the ratchet.

14. The ratchet of claim 9, further comprising a ratchet cover substantially enveloping the ratchet, wherein the base defines a bore and the ratchet cover defines at least two detents, and wherein the ratchet further comprises a spring and ball positioned in the bore for engaging a selected one of the at least two detents for securing the ratchet in the clockwise position or the counterclockwise position.

15. The ratchet of claim 9, wherein the upper bearing includes a cover portion configured for substantially enveloping the ratchet, wherein the base defines a bore and the cover portion defines at least two detents, and wherein the ratchet further comprises a spring and ball positioned in the bore for engaging a selected one of the at least two detents for securing the ratchet in the clockwise position or the counterclockwise position.

16. The ratchet of claim 9, further comprising a lower bearing interposed in the shaft bore between the shaft and the shaft bore.

17. A ratchet mechanism comprising:
a base mountable to a handle, the base defining a first pawl cavity, a second pawl cavity, and a shaft bore;
a shaft rotatably positioned in the shaft bore, the shaft including gear teeth circumscribing at least a portion of the shaft proximate to the first and second pawl cavities;
an upper bearing mounted on the base, the upper bearing defining a first hole and a second hole, the upper bearing being selectively rotatable to at least a clockwise position for imparting torque in a clockwise direction from a handle to the shaft, the upper bearing being further selectively rotatable to at least a counterclockwise position for imparting torque in a counterclockwise direction from a handle to the shaft;
a first pawl slidably positioned in the first pawl cavity, the first pawl being fabricated from a ferromagnetic material and slidable between an engaged position in which the first pawl engages the gear teeth, and a disengaged position in which the first pawl is not engaged with the gear teeth;
a second pawl slidably positioned in the second pawl cavity, the second pawl being fabricated from a ferromagnetic material and slidable between an engaged position in which the second pawl engages the gear teeth, and a disengaged position in which the second pawl is not engaged with the gear teeth;
a first magnet embedded in the base in magnetic relation to the first pawl for biasing the first pawl toward the first magnet such that when the upper bearing is rotated to the clockwise position, the first magnet biases the first pawl to the engaged position;
a second magnet embedded in the base in magnetic relation to the second pawl for biasing the second pawl toward the second magnet such that when the upper bearing is rotated to the counterclockwise position, the second magnet biases the second pawl to the engaged position;
a first pin embedded in the first pawl and extending into the first bearing hole, wherein when the upper bearing is rotated to the counterclockwise position, the first pin restrains the first pawl from sliding into the engaged position; and
a second pin embedded in the second pawl and extending into the second bearing hole, wherein when the upper bearing is rotated to the clockwise position, the second pin restrains the second pawl from sliding into the engaged position.

18. The ratchet of claim 17, wherein the shaft further includes a driver at an end thereof, for tightening and loosening fasteners.

19. The ratchet of claim 17, wherein the upper bearing is further selectively rotatable to a bi-directional position for imparting torque in both a clockwise direction and a counterclockwise direction from a handle to the shaft.

20. The ratchet of claim 17, further comprising a ratchet cover substantially enveloping the ratchet.

21. The ratchet of claim 17, wherein the upper bearing includes a cover portion configured for substantially enveloping the ratchet.

22. The ratchet of claim 17, further comprising a ratchet cover substantially enveloping the ratchet, wherein the base defines a bore and the ratchet cover defines at least two detents, and wherein the ratchet further comprises a spring and ball positioned in the bore for engaging a selected one of the at least two detents for securing the ratchet in the clockwise position or the counterclockwise position.

23. The ratchet of claim 17, wherein the upper bearing includes a cover portion configured for substantially enveloping the ratchet, wherein the base defines a bore and the cover portion defines at least two detents, and wherein the ratchet further comprises a spring and ball positioned in the bore for engaging a selected one of the at least two detents for securing the ratchet in the clockwise position or the counterclockwise position.

24. The ratchet of claim 17, further comprising a lower bearing interposed in the shaft bore between the shaft and the shaft bore.

25. The ratchet of claim 17, wherein the first magnet and the second magnet comprise Halbach arrays of magnets.
